(19) United States
(12) Patent Application Publication
(10) Pub. No.: US 2010/0230334 A1
(43) Pub. Date: Sep. 16, 2010

(54) FILTER UNIT FOR SEPARATING TARGET MATERIAL AND MICROFLUIDIC DEVICE INCLUDING THE FILTER UNIT

(75) Inventors: Jon-won RHEE, Seoul (KR); June-young LEE, Anyang-si (KR); Chin-sung PARK, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/616,998

(22) Filed: Nov. 12, 2009

(30) Foreign Application Priority Data
Mar. 12, 2009 (KR) 10-2009-0021242

(51) Int. Cl. B01D 15/18; B01D 15/42

(52) U.S. Cl. 210/137; 210/198.2

(57) ABSTRACT

A filter unit for separating target materials from microparticles using an eluent includes: an inlet; a separator unit which separates the target materials from the microparticles using the eluent; an outlet; and a filter which is interposed between the outlet and the separator unit and filters the microparticles. A volume of the separator unit is less than a volume of the eluent provided to the separator unit.

### CROSS-REFERENCE TO RELATED APPLICATION

This application claims priority to Korean Patent Application No. 10-2009-0021242, filed on Mar. 12, 2009, and all the benefits accruing therefrom under 35 U.S.C. §119, the content of which in its entirety is herein incorporated by reference.

### BACKGROUND

1) Field

The general inventive concept relates to a filter unit and, more particularly, the general inventive concept relates to a filter unit that separates target materials, such as nucleic acid and protein, for example, from samples using microparticles, and a microfluidic device that includes the filter unit.

2) Description of the Related Art

Clinical or environmental samples are generally analyzed through a series of biochemical, chemical and mechanical processes. Technical developments in diagnosing and monitoring biological samples have been made, and molecular diagnosis performed based on nucleic acid has improved diagnosing and monitoring accuracy and/or sensitivity. Thus, molecular diagnosis is widely used for detecting infectious diseases, cancer diagnosis and pharmacogenomics, for example.

Nucleic acid used in polymerase chain reaction (“PCR”) devices, molecular diagnosis devices, point of care test (“POCT”) devices, nucleic acid analyzing devices or nucleic acid sequencing devices, for example, is typically separated from a biological sample and refined. Refinement of the nucleic acid may include collecting the nucleic acid from biological samples using a probe bonded with the nucleic acid and separating the nucleic acid from the probe using an eluent. In general, it is desired to have a high nucleic acid refinement efficiency and a high concentration of nucleic acid in the effluent. However, to increase the nucleic acid refinement efficiency, a large volume of eluent is required. As a result, a concentration of the nucleic acid in the eluent is substantially decreased, due to the large amount of effluent used. Conversely, to increase the concentration of nucleic acid in the eluent, a smaller volume of eluent should to be used. In this case, the nucleic acid refinement efficiency is substantially decreased. Thus, there is a substantial need to develop a device having a high nucleic acid refinement efficiency, as well as a high concentration of nucleic acid in the effluent.

### SUMMARY

An exemplary embodiment of the present invention includes a filter unit which collects target materials from a sample using microparticles, and which separates fluid including target materials from the microparticles, and a microfluidic device including the filter unit.

An exemplary embodiment includes a filter unit that substantially increases refinement efficiency using a substantially reduced volume of eluent and a microfluidic device including the filter unit.

An exemplary embodiment includes a filter unit which separates target materials from microparticles using an eluent. The filter unit includes: an inlet; a separator unit which separates the target materials from the microparticles using the eluent; an outlet; and a filter which is interposed between the outlet and the separator unit and filters the microparticles, where a volume of the separator unit is less than a volume of the eluent provided to the separator unit.

In another exemplary embodiment, a volume of the outlet may be from about 1/100 to about 1/10 of a volume of the separator unit.

In an exemplary embodiment, a microfluidic device includes: a filter unit, a fluid providing unit, and a fluid accommodation unit. The filter unit includes an inlet, a separator unit, an outlet, and a filter. The separator unit separates target materials from the microparticles using an eluent, and the filter is interposed between the outlet and the separator unit, and filters the microparticles, where a volume of the separator unit is less than a volume of the eluent provided to the filter unit. The fluid providing unit provides a sample solution and the eluent through the inlet. The sample solution includes microparticles which collect the target materials at surfaces thereof. The fluid accommodation unit accommodates fluid provided from the outlet. In another exemplary embodiment, a volume of the outlet may be from about 1/100 to about 1/10 of the volume of the separator unit.

The fluid providing unit may include: a sample chamber which accommodates the sample solution; an eluent chamber which accommodates the eluent; a supply channel which connects the sample chamber and the eluent chamber to the inlet of the filter unit; and a supply valve which controls flow between the supply channel and at least one of the sample chamber and eluent chamber.

The fluid providing unit may further include a washing solution chamber which accommodates a washing solution. The washing solution may wash impurities of the microparticles collected in the separator unit.

The fluid accommodation unit may include: a waste chamber which accommodates the sample solution and washing solution provided from the filter unit; a target material accommodation chamber which accommodates the eluent including the target materials separated from the microparticles; a discharge channel which connects the waste chamber and the target material accommodation chamber to the outlet of the filter unit; and an accommodation valve which controls flow between the discharge channel and at least one of the waste chamber and target material accommodation chamber.

In an exemplary embodiment, a microfluidic device includes: a filter unit and a platform. The filter unit includes an inlet, an outlet, and a filter. The filter is interposed between the inlet and the outlet and filters microparticles which collect target materials at surfaces thereof. The platform includes a fluid providing unit and a fluid accommodation unit. The fluid providing unit provides a sample solution including the microparticles which collect the target materials at surfaces thereof, and an eluent which separates the target materials from the microparticles through the inlet. The fluid accommodation unit accommodates fluid provided from the outlet. The filter unit is separated from the platform, and is connected to the fluid providing unit through first connecting members and to the fluid accommodation unit through second connecting members.

### BRIEF DESCRIPTION OF THE DRAWINGS

The above and other aspects, advantages and features of the present invention will become more apparent by describing in further detail exemplary embodiments thereof with reference to the accompanying drawings, in which:

FIG. 1 is a plan view of an exemplary embodiment of a microfluidic device according to the present invention;

FIG. 2 is a plan view of an exemplary embodiment of a filter unit of the microfluidic device in FIG. 1;

FIG. 3A is a cross-sectional view of a valve included in the microfluidic device of FIG. 1 in a closed position;

FIG. 3B is a cross-sectional view of an the valve included in the microfluidic device of FIG. 1 in a closed position; and

FIG. 4 is a plan view of an alternative exemplary embodiment of a microfluidic device according to the present invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

FIG. 1 is a plan view of an exemplary embodiment of a microfluidic device 1. The microfluidic device 1 may include a platform 10. The platform may include chambers, channels which connect the chambers and valves which control fluid flowing through the channels. The platform 10 may include more than one plate. In an exemplary embodiment, the platform 10 may include a lower plate, in which the chambers, the channels and the valves are disposed, and an upper plate, where the lower plate is combined with the upper plate. The platform 10 may include a partition plate including the chambers, the channels and the valves, where the partition plate is interposed between a lower plate and an upper plate. In another exemplary embodiment, the platform 10 may be manufactured in various forms.

The microfluidic device 1 collects target materials included in a sample solution (for example, a biological sample) using microparticles. The microfluidic device 1 separates the target materials from the microparticles and obtains a fluid including the target materials. In the sample solution, probes specifically bonded with the target materials are disposed on the surfaces of the microparticles. An exemplary embodiment of the microparticles may include, but is not limited to, silica particles or inorganic oxides. The inorganic oxides may be, for example, glass particles, alumina (e.g., aluminum oxide), zirconia (e.g., zirconium dioxide), or titania (e.g., titanium dioxide). The biological sample may include, but is not limited to, a cell suspension, human blood, urine or saliva. In addition, the target materials may be, for example, nucleic acid, protein, peptides, antibodies or hormones. The nucleic acid may include, but is not limited to, deoxyribonucleic acid (“DNA”) or ribonucleic acid (“RNA”).

In an exemplary embodiment shown in FIG. 1, the microfluidic device 1 includes a fluid providing unit 100, a filter unit 200, and a fluid accommodation unit 300. The fluid providing unit 100 may include a sample chamber 110 where the sample chamber 110 accommodates the sample solution including the target materials, and an eluent chamber 120 that accommodates an eluent that separates the target materials from the microparticles. The microparticles may be accommodated in the sample chamber 110 along with the sample solution. The microfluidic device 1 according to an exemplary embodiment may include a microparticle accommodation chamber (not shown) that accommodates fluid including the microparticles. In an exemplary embodiment, the microparticle accommodation chamber may be connected to the sample chamber 110 by a channel (not shown), and the fluid including the microparticles may be provided to the sample chamber 110 and mixed with the sample solution. The fluid providing unit 100 may further include a washing solution chamber 130, which accommodates a washing solution and thus substantially increases purity of the target materials.

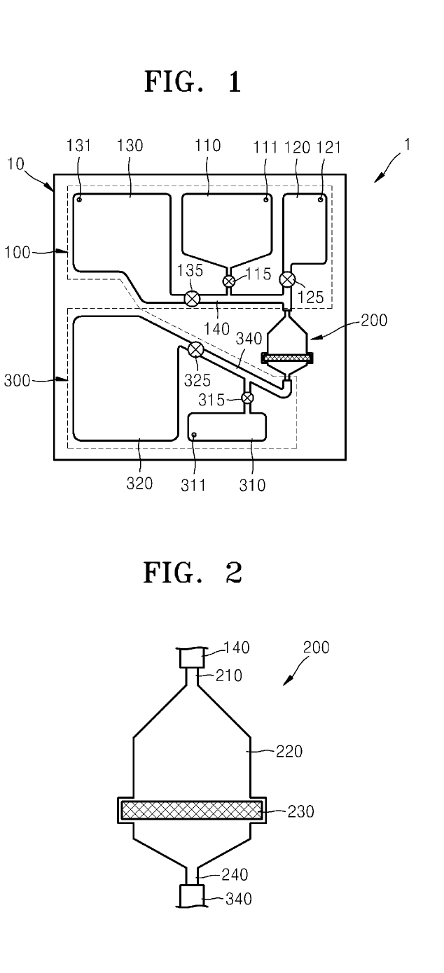

The filter unit 200 filters the microparticles from the fluid. FIG. 2 is a plan view of an exemplary embodiment of the filter unit 200 in the microfluidic device 1 of FIG. 1. In an exemplary embodiment shown in FIG. 2, the filter unit 200 includes an inlet 210, a separator unit 220, an outlet 240 and a filter 230. The separator unit 220 separates the target from the microparticles using the eluent, and the filter 230 is interposed between the outlet 240 and the separator unit 220. The filter 230 may include a porous material that filters the microparticles. The filter 230 may be selected based on diameters of the microparticles.

The fluid accommodation unit 300 may include a target material accommodation chamber 310 and a waste chamber 320. The target material accommodation chamber 310 accommodates the eluent including the target materials separated from the microparticles. The waste chamber 320 accommodates the sample solution and the washing solution provided from the filter unit 200. The target material accommodation chamber 310 may further include an extraction hole 311 which extracts the eluent including the target materials.

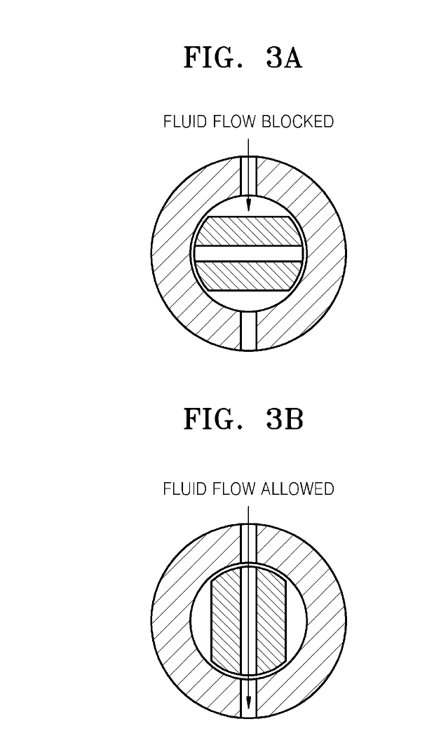

The sample chamber 110, the eluent chamber 120, and the washing solution chamber 130 are connected to the inlet 210 of the filter unit 200 through a supply channel 140. In exemplary embodiment, valves 115, 125 and 135 are supply valves that control fluid flow between the supply channel 140 and the sample chamber 110, eluent chamber 120 and/or the washing solution chamber 130. The valves 115, 125 and 135 are operated to provide the sample solution, the eluent and the washing solution to the filter unit 200. The target material accommodation chamber 310 and the waste chamber 320 are connected to the outlet 240 of the filter unit 200 through a discharge channel 340. Valves 315 and 325 are accommodation valves which controls fluid flow between discharge channel 340 and one of the target material accommodation chamber 310 and waste chamber 320 respectively. The valves 115, 125, 135, 315, and 325 may be any valves which may be opened and closed. In an exemplary embodiment, a 2-way valve may block fluid using a pneumatic device or manual operation as shown in FIG. 3A, or may allow fluid to flow as shown in FIG. 3B.

The fluid may flow in the microfluidic device 1 using, for example, gas pressure provided from the external source. Accordingly, gas inlets 111, 121 and 131 are included in the sample chamber 110, the eluent chamber 120 and the washing solution chamber 130, respectively.

Hereinafter, exemplary embodiments of a method for refining the target materials will be described in further detail.

The sample solution including the target materials, the eluent and the washing solution is loaded into the sample chamber 110, the eluent chamber 120 and the washing solution chamber 130, respectively. The sample solution may include the microparticles. The microfluidic device 1 includes a microparticle accommodation chamber (not shown) that accommodates the fluid including the microparticles. The gas pressure is applied to the microparticle accommodation chamber and the fluid including the microparticles may thereby be provided to the sample chamber 110. The target materials in the sample chamber 110 are collected at the surfaces of the microparticles using specific bonds with the probes disposed on the surfaces of the microparticles.

The sample solution is provided to the filter unit 200. The valves 115 and 325 are opened, and gas pressure is thereby applied to the sample chamber 110 through the gas inlet 111. The sample solution is provided to the filter unit 200 through the supply channel 140. The microparticles cannot pass through the filter 230, and thus only the sample solution passes through the filter 230. The sample solution is provided to the waste chamber 320 through the discharge channel 340. The microparticles, in which the target materials are collected, remain in the separator unit 220 of the filter unit 200. When the sample solution is discharged, the valve 115 is closed.

A process of removing impurities mixed with the microparticles in the separator unit 220 may also be performed. More specifically, the valve 135 is opened. Gas pressure is applied to the washing solution chamber 130 through the gas inlet 131 and the washing solution is thereby provided to the filter unit 200. The impurities mixed with the microparticles in the separator unit 220 pass through the filter 230 along with the washing solution and are provided to the waste chamber 320 through the discharge channel 340. The washing solution is completed discharged, and the valves 135 and 325 are closed.

In an exemplary embodiment, a process of separating the target materials collected at the surfaces of the microparticles is performed. More particularly, the valve 125 is opened. Gas pressure is applied to the eluent chamber 120 through the gas inlet 121 and the eluent is provided to the filter unit 200. By using the eluent within the separator unit 220, specific combinations of the probes and the target materials on the surfaces of the microparticles are broken. The eluent including the target materials flows into the discharge channel 340 through the outlet 240. The valve 315 is opened, and the eluent including the target materials is provided to the target material accommodation chamber 310.

In an exemplary embodiment, the target materials may be separated and refined from the sample solution. In an exemplary embodiment, for a suitably high concentration of the target materials in the eluent, a relatively small volume of the eluent is used to separate the target materials. Accordingly, a highly efficient method of separating the microparticles and the target materials in the separator unit 220 is provided in an exemplary embodiment. The eluent may break the specific combinations of the probes and the target materials on the microparticles. Thus, when the eluent wets the microparticles in the separator unit 220, efficiency of separating the microparticles and the target materials substantially increases. Accordingly, a volume of the separator unit 220 is substantially less than a total volume of the eluent provided to the filter unit 200. In addition, the eluent fills the separator unit 220 and the eluent thereby contacts all of the microparticles in the separator unit 220, and the efficiency of separating is substantially increased.

In an exemplary embodiment, the time that the eluent remains in the separator unit 220 may be delayed prior to discharge of the eluent. Accordingly, a volume of the outlet 240 is substantially reduced. In an exemplary embodiment, the volume of the outlet 240 in FIG. 2 may be from about 1/100 to about 1/10 of the volume of the separator unit 220. A cross-sectional area and/or length of the outlet 240 may be determined such that the volume of the outlet 240 is from about 1/100 to about 1/10 of the volume of the separator unit 220. In an exemplary embodiment, the length of the outlet 240 may be at least a few hundred microns or more.

In order for the eluent to not flow into the separator unit 220 too rapidly, a volume of the inlet 210 may be controlled. In an exemplary embodiment, for example, the volume of the inlet 210 may be from about 1/100 to about 1/10 of the volume of the separator unit 220. The cross-section and length of the inlet 210 may be determined such that the volume of the inlet 210 is from about 1/100 to about 1/10 of the volume of the separator unit 220. The length of the inlet 210 may be at least a few hundred microns or more, but alternative exemplary embodiments are not limited thereto.

The filter unit 200 was used to conduct experiments for refining DNA from two different sample solutions. More specifically, a first sample solution included a large amount of DNA and a second sample solution included a small amount of DNA (relative to the first sample solution).

The following experiments were performed to further describe the exemplary embodiments. However, these examples are for illustrative purposes only and are not to limit the scope of the exemplary embodiments described herein.

The following components and parameters describe a filter unit used in experiments.

Volume of a separator unit: about 30 microliters (uL).

Filter: nitro-cellulose having a 1.2 micrometer (um) pore size (manufactured by Millipore Co. Ltd., cat. No. RAWPO4700).

Volume of inlet: about 0.135 uL (diameter: 1/16 inch, length: 0.5 millimeter (mm)).

Capacity of outlet: about 0.135 uL (diameter: 1/16 inch, length: 0.5 mm).

Experiment 1: First Sample Solution.

Sample solution: 125 uL including 100 micrograms (ug) of DNA having an average dispersion of about 1 kilobasepair (kbp) to about 2 kbp and impurities (protein, salt, dNTP, and detergent)

Negative control group: AMPURE® (cat. No. A29152) PCR wash up KIT manufactured by Agencourt Co. Ltd.

Experiment using the negative control group: According to an AMPURE® KIT manual, Agencourt SPRISTAND® Magnetic 6-tube stand is use in this experiment. In consideration of the relatively high concentration of DNA, 250 uL of the solution including the microparticles, which is double that of the sample solution, was used. The microparticles were used to collect DNA and were washed using 500 uL of 70% ethanol. Then, the washed microparticles were dried for 20 minutes in the air and were eluted using 45 uL of deionized water.

Experiment using the filter unit: 250 uL of the solution including the microparticles, which is the same as the negative control group, was mixed with 125 uL of the sample solution to manufacture a mixture solution. Then, the mixture solution was passed through the filter unit for 20 minutes at a pressure of about 20 pounds per square inch (psi). 500 uL of 70% ethanol was also passed through the filter unit for 20 minutes at a pressure of about 20 psi and then the microparticles were washed and dried by flowing air into the filter unit at a pressure of about 20 psi. The dried microparticles were eluted using 45 uL of deionized water. This experiment was conducted twice.

Result of experiment: DNA concentration, protein pollution level, salt pollution level, DNA yield, and volume of the collected eluent were as shown in Table 1 below.

TABLE 1

| | DNA | protein | | | |
|---|---|---|---|---|---|
| | concen- | pollution | Salt | DNA | volume of |
| | tration | level | pollution | yield | eluent |
| | (ng/uL) | (260/280) | (260/230) | (%) | (uL) |
| Negative | 1137.08 | 1.72 | 2.13 | 49 | 45 |
| control group | | | | | |
| filter unit 1 | 1538.79 | 1.86 | 2.39 | 66 | 43 |
| filter unit 2 | 1674.63 | 1.87 | 2.37 | 71 | 43 |

As shown in Table 1 above, when the filter unit according to an exemplary embodiment is used, a high concentration of DNA may be collected compared with the negative control group. In addition, yield is substantially higher than a yield of the negative control group.

Experiment 2: Second Sample Solution.

Sample solution: 500 uL including 260 ug of DNA having an average dispersion of about 1 to about 2 kb and impurities (protein, salt, dNTP, and detergent)

Negative control group: AMPURE® (cat. No. A29152) PCR wash up KIT manufactured by Agencourt Co. Ltd.

Experiment using the negative control group: According to an AMPURE® KIT manual, Agencourt SPRISTAND® Magnetic 6-tube stand is used in this experiment and 1000 uL of the solution including the microparticles, which is double that of the sample solution, was used. The microparticles were used to collect DNA and were washed using 500 uL of 70% ethanol. Then, the washed microparticles were dried for 20 minutes in the air and were eluted using 45 uL of deionized water.

Experiment using the filter unit: 1000 uL of the solution including the microparticles, which is substantially same as the negative control group, was mixed with 500 uL of the sample solution to manufacture a mixture solution. Then, the mixture solution was passed through the filter unit for 20 minutes at a pressure of about 20 psi. 500 uL of 70% ethanol was also passed through the filter unit for 20 minutes at a pressure of about 20 psi and then the microparticles were washed and dried by flowing air into the filter unit at a pressure of about 20 psi. The dried microparticles were eluted using 45 uL of deionized water. This experiment was conducted three times.

Result of experiment: a DNA concentration, a protein pollution level, a salt pollution level, and a DNA yield were as shown in Table 2 below.

TABLE 2

| | DNA | protein | Salt | DNA |
|---|---|---|---|---|
| | concentration | pollution level | pollution | yield |
| | (ng/uL) | (260/280) | (260/230) | (%) |
| Negative | N.A | N.A | N.A | N.A |
| control group | | | | |
| filter unit 1 | 3.1335 | 1.85 | 2.39 | 52% |
| filter unit 2 | 3.6060 | 1.85 | 2.37 | 60% |
| filter unit 3 | 3.1307 | 1.85 | 2.36 | 52% |

As shown in Table 2 above, 1000 uL of the solution including the microparticles was used in the negative control group. Thus, after the microparticles were sufficiently dried, when the 45 uL of deionized water was used to wet the microparticles and a stand reaction was performed at magnetic stand, the amount of DNA collected using a pipette was insignificant. This is because the amount of the microparticles was relatively large and the amount of deionized water used as the eluent was very small, and thus most of the deionized water was absorbed into the microparticles. When the filter unit according to an exemplary embodiment was used, a high concentration of DNA of about 3 ug/uL or above may be obtained using a small volume of the eluent.

As shown in the experiments above, when the filter unit according to an exemplary embodiment is used, a small volume of eluent is used to separate a high concentration of DNA from the sample solutions including low or high DNA concentration. In an exemplary embodiment, a considerable concentration of DNA may be secured without a separate concentrating process after a refining process. Accordingly, the filter unit according to an exemplary embodiment may be widely used in amplification and signal generation fields, for example, a micro-array and a polymerase chain reaction (“PCR”) where high concentration of DNA is needed. In addition, the filter unit may be used in various molecular biology applications using high concentration of DNA, for example, molecular cloning, gene library generation, and nucleic acid sequencing. Moreover, efficiency of reactions, such as a restriction endonuclease reaction, a ligation reaction, an extension reaction, and a PCR, for example, performed after DNA extraction and refining are substantially improved.

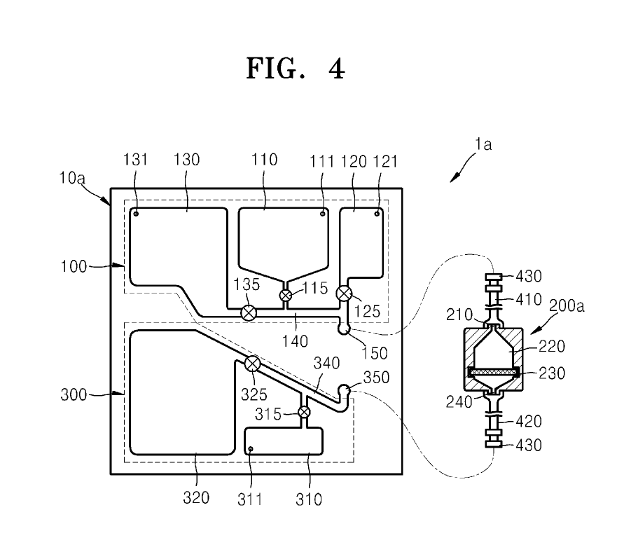

FIG. 4 is a plan view of another alternative exemplary embodiment of a microfluidic device. The same or like elements shown in FIG. 4 have been labeled with the same reference characters as used above to describe the exemplary embodiments of the microfluidic device 1 shown in FIG. 1, and any repetitive detailed description thereof will hereinafter be omitted or simplified.

In an exemplary embodiment, a microfluidic device 1a includes a filter unit 200a disposed separate from a platform 10a. The filter unit 200a is connected to the supply channel 140 and the discharge channel 340 by a first connecting member 410 and a second connecting member 420. The supply channel 140 and the discharge channel 340 respectively include a first connecting port 150 and a second connecting port 350. Both ends of the first connecting member 410 are respectively connected to the inlet 210 of the filter unit 200a and the first connecting port 150. Both ends of the second connecting member 420 are respectively connected to the outlet 240 of the filter unit 200a and the second connecting port 350. Sealing members 430 which may substantially prevent leakage of the fluid are respectively disposed into one of the both ends of the first connecting members 410 and one of the both ends of the second connecting members 420 which are respectively connected to the first connecting port 150 and the second connecting port 350. The sealing members 430 may be disposed into the first connecting port 150 and the second connecting port 350. The first connecting member 410 and the second connecting member 420 may be, for example, flexible tubes.

In an exemplary embodiment, an amount of the sample solution increases, and a large amount of the microparticles and eluent may be used. Thus, the size of the filter unit 200a may be substantially large. In an exemplary embodiment, if the filter unit 200a is large, the filter unit 200a may not be substantially accommodated in the platform 10a which has a limited size. In addition, based on the type of the target materials to be refined, the filter 230 may be formed of various materials. In an exemplary embodiment of the microfluidic device 1a, the filter unit 200a including the filter 230 of which a size is predetermined based on its use may be connected to the platform 10a.

According to exemplary experiments described herein, exemplary embodiments which provide separation of DNA are described. However, it will be noted that alternative exemplary embodiments are not limited thereto. For example, a filter unit and microfluidic device including the filter unit according to alternative exemplary embodiments may be used for refinement of various other target materials using microparticles and eluent, based on the type of the target materials to be refined.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A filter unit for separating target materials from microparticles using an eluent, the filter unit comprising:
an inlet;
a separator unit which separates the target materials from the microparticles using the eluent;
an outlet; and
a filter which is interposed between the outlet and the separator unit and filters the microparticles,
wherein a volume of the separator unit is less than a volume of the eluent provided to the separator unit.

2. The filter unit of claim 1, wherein a volume of the outlet is from about 1/100 to about 1/10 of the volume of the separator unit.

3. A microfluidic device comprising:
a filter unit comprising:
an inlet;
a separator unit which separates target materials from microparticles using an eluent;
an outlet; and
a filter which is interposed between the outlet and the separator unit and filters the microparticles,
wherein a volume of the separator unit is less than a volume of the eluent provided to the filter unit;
a fluid providing unit which provides a sample solution and the eluent to the inlet, the sample solution including the microparticles which collect the target materials at surfaces thereof; and
a fluid accommodation unit which accommodates fluid provided from the outlet.

4. The device of claim 3, wherein a volume of the outlet is from about 1/100 to about 1/10 of the volume of the separator unit.

5. The device of claim 3, wherein the fluid providing unit comprises:
a sample chamber which accommodates the sample solution;
an eluent chamber which accommodates the eluent;
a supply channel which connects the sample chamber and the eluent chamber to the inlet of the filter unit; and
a supply valve which controls flow between the supply channel and at least one of the sample chamber and the eluent chamber.

6. The device of claim 5, wherein the fluid providing unit further comprises a washing solution chamber which accommodates a washing solution, wherein the washing solution washes impurities of the microparticles collected in the separator unit.

7. The device of claim 6, wherein the fluid accommodation unit comprises:
a waste chamber which accommodates the sample solution and the washing solution provided from the filter unit;
a target material accommodation chamber which accommodates the eluent including the target materials separated from the microparticles;
a discharge channel which connects the waste chamber and the target material accommodation chamber to the outlet of the filter unit; and
an accommodation valve which controls flow between the discharge channel and at least one of the waste chamber and the target material accommodation chamber.

8. A microfluidic device comprising:
a filter unit comprising:
an inlet;
an outlet; and
a filter which is interposed between the inlet and the outlet and filters microparticles;
a platform comprising:
a fluid providing unit which provides a sample solution and an eluent to the inlet, wherein the sample solution includes the microparticles which collect the target materials at surfaces thereof, and the eluent separates the target materials from the microparticles; and
a fluid accommodation unit which accommodates fluid provided from the outlet,
wherein the filter unit is separated from the platform, the inlet is connected to the fluid providing unit through first connecting members and the outlet is connected to the fluid accommodation unit through second connecting members.

9. The microfluidic device of claim 8, wherein the filter unit comprises a separator unit which separates the target materials from the microparticles using the eluent, and a volume of the separator unit is less than a volume of the eluent.

10. The microfluidic device of claim 9, wherein a volume of the outlet is about 1/100 to about 1/10 of the volume of the separator unit.

11. The microfluidic device of claim 8, wherein the fluid providing unit comprises:
a sample chamber which accommodates the sample solution;
an eluent chamber which accommodates the eluent;
a supply channel which connects the sample chamber and the eluent chamber to the inlet of the filter unit; and
a supply valve which controls flow between the supply channel and at least one of the sample chamber and eluent chamber.

12. The microfluidic device of claim 11, wherein the fluid providing unit further comprises a washing solution chamber which accommodates a washing solution, wherein the washing solution washes impurities of the microparticles in the separator unit.

13. The microfluidic device of claim 12, wherein the fluid accommodation unit comprises:
a waste chamber which accommodates the sample solution and the washing solution provided from the filter unit;
a target material accommodation chamber which accommodates the eluent including the target materials separated from the microparticles;
a discharge channel which connects the waste chamber and the target material accommodation chamber to the outlet of the filter unit; and
an accommodation valve which controls flow between the discharge channel and at least one of the waste chamber and the target material accommodation chamber.
